(19) United States
(12) Patent Application Publication
(10) Pub. No.: US 2006/0010917 A1
(43) Pub. Date: Jan. 19, 2006

(54) Glass for an illuminating means with external electrodes

(75) Inventors: Jorg Fechner, Malnz (DE); Martin Letz, Kleln-Wlnternhelm (DE); Steffen Reichel, Mehllngen (DE); Franz Ott, Konnersreuth (DE); Brigitte Hueber, Schwandorf (DE)

Correspondence Address: Charles N.J. Ruggiero, Esq.;Ohlandt, Greeley, Ruggiero & Perle, L.L.P., One Landmark Square, 10th Floor, Stamford, CT, 06901-2682, US

(73) Assignee: Schott AG

(21) Appl. No.: 11/178,835

(22) Filed: Jul. 11, 2005

(30) Foreign Application Priority Data
Jul. 12, 2004 (DE) 10 2004 033 652.0
Jul. 12, 2004 (DE) 10 2004 033 653.9
Jan. 4, 2005 (DE) 10 2005 000 660.4
Jan. 4, 2005 (DE) 10 2005 000 663.9
Jan. 4, 2005 (DE) 10 2005 000 664.7
Mar. 19, 2005 (DE) 20 2005 004 459.8

(51) Int. Cl. C03B 13/00

(52) U.S. Cl. 65/101

(57) ABSTRACT

A glass composition for a glass body of an illuminating device with external electrodes is provided. In the glass composition, the quotient of the loss angle and the dielectric constant amounts to tan δ/ε′<5. In this way, the total power loss of the illuminating device can be minimized in a targeted manner by the glass properties.

The invention concerns a glass for a glass body of illuminating means with external electrodes, such as, for example, a fluorescent lamp, in particular an EEFL fluorescent lamp.

Glasses with UV-absorbing properties, which are known in and of themselves, are usually used for the production of liquid crystal displays (LCDs), monitors, and other image screens, as well as for the production of gas-discharge tubes, in particular of fluorescent lamps. Such glasses are used, among other things, as light sources for back-illuminated image screens (so-called backlight displays). Such fluorescent lamps for this application should have only very small dimensions and, correspondingly, the lamp glass should have only an extremely small thickness.

The illuminating gas contained in such lamps is ignited, i.e., illuminated, by applying an electrical voltage by means of electrodes. Usually the electrodes are disposed inside the lamp, i.e., an electrically conducting metal wire is passed through the lamp glass in a gas-tight manner. However, it is also possible to ignite the illuminating gas or the plasma present inside the lamp by an externally applied electrical field, i.e., by external electrodes, which are not passed through the lamp glass.

Such lamps are usually called EEFL lamps (external electrode fluorescent lamps). It is important in this case that the irradiated high-frequency energy is not absorbed by the lamp glass or is absorbed only to a slight extent, in order to ignite the illuminating gas enclosed within the fluorescent lamp. Up until now, it has been assumed that the glass should have an extremely small dielectric constant as well as an extremely small dielectric loss angle tan δ. Thus, the dielectric loss angle serves as a measurement for the energy that is absorbed by the glass in the excited dielectric alternating field and which is converted to heat loss. Accordingly, very particular requirements are placed on the glass and its properties.

Accordingly, the object of the present invention is to provide another glass, which, in addition to other applications, will be suitable also for displays or screens, for example, for backlight displays, in particular, illuminating means with external electrodes, such as fluorescent lamps, which can be externally ignited by induction and do not require metal wires or electrodes that are passed through the enveloping lamp glass. In this way, a glass should be made available whose properties can be modified and optimized in such a way that as little as possible high-frequency energy that is irradiated is absorbed, i.e, the total power loss of a lamp glass of an illuminating means with external electrodes should be reduced to a minimum. In addition, the glass composition shall have good UV-absorbing properties.

According to the invention, the object is solved by a glass composition for a glass body of an illuminating means with external electrodes, wherein the quotient of the loss angle and the dielectric constant tan δ/ε′ amounts to <5, preferably <4 and <3, most particularly preferred <2 and <1.5. A most particularly preferred embodiment possesses a tan δ/ε′ of <1. In particular, the quotient can also be adjusted to <0.7 and <0.5.

The invention thus concerns a glass for a glass body of an illuminating means with external electrodes, in which, in order to obtain a power loss Pₗₒₛₛ that is as small as possible and thus an efficiency that is as high as possible, the quotient of the loss angle tan δ and the dielectric constant ε′ should not reach a specific upper limit. The plasma is ignited externally here, whereby the glass functions as a capacitor. For a simple geometry with planar elektrodes on the end surfaces of a closed glass tube, the power loss can be described approximately by:

$${P}_{loss} \approx 2 \cdot \frac{1}{ω} \cdot \frac{tan δ}{{ɛ}^{′}} \cdot \frac{d}{A} \cdot {I}^{2} \vert$$

wherein the following apply:
ω: angular frequency
tan δ: loss angle
ε′: dielectric constant
d: thickness of the capacitor (here: thickness of the glass)
A: electrode surface and
I: current intensity

Accordingly, the glass properties are influenced in a targeted manner by adjusting the quotient tan δ/ε′ in a specific range, whereby the desired total power loss can be minimized. This can be achieved by employing the glasses according to the invention.

According to the invention, it was surprisingly found that the object named above can be solved in an extremely cost-favorable manner with the glass compositions according to the invention. This is all the more surprising, since it would be expected that with such glasses, when an a.c. voltage supply is applied, due to the high dielectric constant and based on the high loss angle, the electrical energy would be converted to heat, so that with its use, particularly in fluorescent or gas-illuminating tubes with externally disposed electrodes, a high loss, as well as an extremely high heating of the glass would be expected, which should also lead to a rapid corrosion of the glass material. It has been shown, however, that this is surprisingly not the case and that such a glass is very well suited to such applications. The invention thus particularly concerns glass compositions and their use.

For employing such an illuminating means with external electrodes, such as, for example, an EEFL fluorescent lamp, the quotient lies at <5, preferably <4.5, particularly preferred <4.0, in particular <3, still more preferred <2.5. Particularly good properties are obtained in the range of 0.75-2.5. Most particularly preferred, the quotient is <1.0, particularly <0.75.

In particular, such a quotient can be adjusted in a targeted manner in a glass composition, in particular, in silicate glasses, by incorporating highly polarizable elements in oxide form in the glass matrix. These are, e.g., the oxides of Ba, Hf, Ta, W, Re, Os, Ir, Pt, Pb, Bi, La, Ce, Pr, Nd, Sm, Eu, Gd, Tb, Dy, Ho, Er, Tm, Yb and Lu.

The glasses employed according to the invention and obtainable according to the invention preferably have a relatively high dielectric constant (DC). The dielectric constant at 1 MHz at 25° C. preferably amounts to >3 and >4, in particular lies in the range of 3.5 to 4.5, and more preferably amounts to >5 and >6, most particularly preferred >8. The dielectric loss factor tan δ [10⁻⁴] preferably amounts to a maximum of 120 and preferably to less than 100. Particularly preferred are loss factors of less than 80, wherein values of less than 50 and less than 30 are particularly suitable. Most particularly preferred are values of less than 15, in particular, a range between 1 and 15. The tan δ values can fluctuate, each time depending on the extent of impurities and on the production method. It is not a deciding factor, however, to adjust the individual values of loss angle tan δ and the dielectric constant ε′ to be as small as possible and independent of one another, but rather to set the two values in a relationship to one another. Actually, the quotient of the two parameters represents the critical value, by means of which the properties of the glass material are adjusted.

The illuminating means with external electrodes is preferably a discharge lamp, such as a gas-discharge lamp, in particular, a low-pressure discharge lamp. In the case of low-pressure lamps, for example, in backlight lamps, the discrete UV lines are partially converted to the visible spectrum by means of the fluorescent layers. Therefore, the illuminating means can also be a fluorescent lamp, in particular an EEFL lamp, and most particularly preferred, a miniature fluorescent lamp.

As the illuminating means utilized according to the invention, for example, in the form of a so-called backlight, any illuminating means known to the person skilled in the art for this purpose can be employed, such as, for example, a discharge lamp such as a low-pressure discharge lamp, in particular a fluorescent lamp, most particularly preferred, a miniature fluorescent lamp.

The glass of the glass body of the illuminating means contains a glass composition according to the invention or consists of it. One or more individual, in particular, miniature illuminating means are used, the glass body of which essentially contains the glasses according to the invention or consists of these.

For an illuminating means with external electrodes, such as an EEFL discharge lamp, the glass thus preferably has the following composition:

| | | |
|---|---|---|
| SiO₂ | 55-85 | wt. % |
| B₂O₃ | >0-35 | wt. % |
| Al₂O₃ | 0-25 | wt. %, |
| preferably | 0-20 | wt. %, |
| Li₂O | <1.0 | wt. % |
| Na₂O | <3.0 | wt. % |
| K₂O | <5.0 | wt. %, wherein |
| the Σ Z Li₂O + Na₂O + K₂O amounts to | <5.0 | wt. %, and |
| MgO | 0-8 | wt. % |
| CaO | 0-20 | wt. % |
| SrO | 0-20 | wt. % |
| BaO | 0-80 | wt. %, |
| particularly BaO | 0-60 | wt. %, |
| TiO₂ | 0-10 | wt. %, |
| preferably amounts to | >0.5-10 | wt. %, |
| ZrO₂ | 0-3 | wt. % |
| CeO₂ | 0-10 | wt. % |
| Fe₂O₃ | 0-3 | wt. %, |
| preferably | 0-1 | wt. %, |
| WO₃ | 0-3 | wt. % |
| Bi₂O₃ | 0-80 | wt. % |
| MoO₃ | 0-3 | wt. %, |
| ZnO | 0-15 | wt. %, |
| preferably | 0-5 | wt. %, |
| PbO | 0-70 | wt. %, wherein |
| the Σ Al₂O₃ + B₂O₃ + BaO + | 15-80 | wt. %, |
| PbO + Bi₂O₃ amounts to | | |

wherein Hf, Ta, W, Re, Os, Ir, Pt, La, Pr, Nd, Sm, Eu, Gd, Th, Dy, Ho, Er, Tm, Yb and/or Lu are present in oxide form in contents of 0-80 wt. %, as well as refining agents in the usual concentrations.

In addition, a particularly preferred embodiment of the glass composition according to the invention is:

| | | |
|---|---|---|
| SiO₂ | 55-85 | wt. % |
| B₂O₃ | >0-35 | wt. % |
| Al₂O₃ | 0-20 | wt. % |
| Li₂O | <0.5 | wt. % |
| Na₂O | <0.5 | wt. % |
| K₂O | <0.5 | wt. %, wherein |
| the Σ Li₂O + Na₂O + K₂O amounts to | <1.0 | wt. %, and |
| MgO | 0-8 | wt. % |
| CaO | 0-20 | wt. % |
| SrO | 0-20 | wt. % |
| BaO | 15-60 | wt. %, |
| particularly BaO | 20-35 | wt. %, wherein |
| the Σ MgO + CaO + SrO + BaO amounts to | 15-70 | wt. %, |
| particularly | 20-40 | wt. %, and |
| TiO₂ amounts to | 0-10 | wt. %, |
| preferably | >0.5-10 | wt. %, |
| ZrO₂ | 0-3 | wt. % |
| CeO₂ | 0-10 | wt. %, |
| preferably | 0-1 | wt. %, |
| Fe₂O₃ | 0-1 | wt. % |
| WO₃ | 0-3 | wt. % |
| Bi₂O₃ | 0-80 | wt. % |
| MoO₃ | 0-3 | wt. %, |
| ZnO | 0-10 | wt. %, |
| preferably | 0-5 | wt. %, |
| PbO | 0-70 | wt. %, wherein |

the Σ Al₂O₃+B₂O₃+Cs₂O+BaO+PbO+Bi₂O₃ amounts to 15-80 wt. %, as well as refining agents in the usual concentrations.

Particularly preferred is glass free of alkalis, except for unavoidable impurites.

Accordingly, borosilicate glasses are particularly preferred as glasses for use in the illuminating means employed according to the invention. Borosilicate glasses comprise as primary components SiO₂ and B₂O₃ und as additional components an alkaline-earth oxide such as e.g., CaO, MgO, SrO and BaO and optionally an alkali oxide such as, e.g., Li₂O, Na₂O und K₂O.

Borosilicate glasses with a content of B₂O₃ between 5 and 15 wt. % show a high chemical stability. In addition, such borosilicate glasses can also be adjusted relative to their coefficient of thermal expansion (so-called CTE) by the selection of the composition range of metals, for example, tungsten, or metal alloys such as KOVAR.

Borosilicate glasses with a content of B₂O₃ between 15 and 25 wt. % show good processability as well as also good adaptation of the thermal expansion coefficient (CTE) to the metall tungsten and the alloy KOVAR (Fe—Co—Ni alloy).

Borosilicate glasses with a content of B₂O₃ between 25 and 35 wt. % show a particularly small dielectric loss factor tan δ when used as a lamp glass, whereby these glasses are particularly advantageous for use according to the invention in lamps which have electrodes disposed outside the lamp bulb, such as electrode-less gas-discharge lamps.

According to one embodiment of the invention, the basic glass usually preferably contains at least 30 wt. % or at least 40 wt. % SiO₂, whereby at least 50 wt. % and preferably at least 55 wt. % are particularly preferred. A most particularly preferred minimum quantity of SiO₂ amounts to 57 wt. %. The maximum quantity of SiO₂ amounts to 85 wt. %, in particular 75 wt. %, whereby 73 wt. % and, in particular, a maximum of 70 wt. % of SiO₂ are most particularly preferred. In addition, ranges of 50-70 wt. % and of 55-65 wt. % are most particularly preferred. Glasses with a very high SiO₂ content are characterized by a small dielectric loss factor tan δ and are thus particularly suitable for the illuminating means with external electrodes according to the invention, such as electrode-less fluorescent lamps, taking into consideration the quotient tan δ/ε′.

B₂O₃ is contained in an amount of more than 0 wt. %, preferably more than 2 wt. %, preferably more than 4 wt. % or 5 wt. % and, in particular, at least 10 wt. % or at least 15 wt. %, wherein at least 16 wt. % is particularly preferred. The highest quantity of B₂O₃ amounts to a maximum of 35 wt. %, but preferably a maximum of 32 wt. %, whereby a maximum of 30 wt. % is particularly preferred.

Although the glass of the invention in individual cases can also be free of Al₂O₃, it usually contains Al₂O₃ in a minimum quantity of 0.1, in particular 0.2 wt. %. Preferred is a minimum content of 0.3, whereby minimum quantities of 0.7, in particular, at least 1.0 wt. % are particularly preferred. The highest quantity of Al₂O₃ amounts to 25 wt. %, whereby a maximum of 20 wt. %, in particular, 15 wt. % are preferred. Ranges of 14 to 17 wt. % are most particularly preferred. In several cases, a maximum quantity of 8 wt. %, in particular, 5 wt. %, has proven sufficient.

The sum of the alkali oxides preferably amounts to <5 wt. %, preferably <1 wt. %. Most particularly preferred, the glass composition is free of alkali, except for unavoidable impurities. Li₂O is preferred in an amount of 0-5, in particular <1.0 wt. %, Na₂O is preferred in an amount of 0-3, in particular <3.0 wt. %, and K₂O is preferably used in an amount of 0-9, in particular <5.0 wt. %, whereby a minimum quantity of ≦0.1 wt. % or ≦0.2 and in particular ≦0.5 wt. % is preferred each time.

The alkaline-earth oxides Mg, Ca and Sr according to the invention are contained in each case in an amount of 0-20 wt. %, and in particular, in an amount of 0-8 wt. % or 0-5 wt. %. The content of individual alkaline-earth oxides amounts to a maximum of 20 wt. % for CaO; in individual cases, however, maximum contents of 18, in particular a maximum of 15 wt. % are sufficient. In several cases, a maximum content of 12 wt. % has been demonstrated to be sufficient. Although the glass according to the invention can also be free of calcium components, the glass according to the invention usually, however, contains at least 1 wt. % CaO, whereby contents of at least 2 wt. %, in particular at least 3 wt. %, are preferred. In practice, a minimum content of 4 wt. % has been demonstrated to be appropriate. The lower limit for MgO in individual cases amounts to 0 wt. %, whereby, however, at least 1 wt. % and preferably at least 2 wt. % are preferred. The maximum content of MgO in the glass according to the invention amounts to 8 wt. %, whereby a maximum of 7 and, in particular, a maximum of 6 wt. % are preferred. SrO can be completely omitted in the glass according to the invention; however, it is preferably contained in an amount of 1 wt. %, in particular, at least 2 wt. %.

In order to adjust the quotient of tan δ and ε′ to be as small as possible according to the invention, the glass composition contains highly polarizable elements in oxide form, incorporated in the glass matrix. Such highly polarized elements in oxide form can be selected from the group consisting of the oxides of Ba, Cs, Hf, Ta, W, Re, Os, Ir, Pt, Pb, Bi, La, Ce, Pr, Nd, Sm, Eu, Gd, Tb, Dy, Ho, Er, Tm, Yb and/or Lu.

Preferably, at least one of these oxides is contained in the glass composition. Mixtures of two or more of these oxides may also be present. At least one of these oxides is thus preferably contained in a quantity of >0 to 80 wt. %, preferably from 5 to 75, particularly preferred 10 to 70 wt. %, in particular, 15 to 65 wt. %. In addition, 15 to 60 wt. %, 20 to 55 or 20 to 50 wt. % are preferred. Even more preferred are 20 to 45 wt. %, in particular, 20 to 40 wt. % or 20 to 35 wt. %. Particularly preferred, the lower limit should not go below 15, in particular 18, preferably 20 wt. %.

Particularly preferred, Cs₂O, BaO, PbO, Bi₂O₃ as well as the rare-earth metal oxides, lanthanum oxide, gadolinium oxide, ytterbium oxide, are present in the glass composition according to the invention.

Particularly preferred, at least 15 wt. %, still more preferred 18 wt. %, in particular, 20 wt. %, and most particularly preferred, more than 25 wt. % of one or more of the highly polarizable elements are contained in oxide form in the glass composition.

The content of CeO₂ preferably amounts to 0-5 wt. %, whereby quantities from 0-1 and, in particular, 0-0.5 wt. % are preferred. The content of Nd₂O₃ preferably amounts to 0-5 wt. %, whereby quantities from 0-2, in particular, 0-1 wt. % are particularly preferred. Bi₂O₃ is preferably present in a quantity of 0 to 80 wt. %, preferably from 5 to 75, particularly preferred 10 to 70 wt. %, in particular, 15 to 65 wt. %. In addition, 15 to 60 wt. %, 20 to 55 or 20 to 50 wt. % are preferred. Even more preferred are 20 to 45 wt. %, in particular, 20 to 40 wt. % or 20 to 35 wt. %.

By the addition of at least one of these polarizable oxides in the surprisingly high contents indicated above, the glass properties can thus be influenced in a targeted manner, so that the total power loss is clearly reduced in comparison to glasses usually employed in lighting devices with external electrodes and can be decreased to a minimum.

The sum of all alkaline-earth oxides according to the invention thus preferably amounts to 0-80 wt. %, particularly 5-75, preferably 10-70 wt. %, particularly preferred 20-60 wt. %, most particularly preferred 20-55 wt. %. Additionally preferred are 20-40 wt. %.

The glass can be free of ZnO, but preferably contains a minimum quantity of 0.1 wt. % and a maximum content of at most 15 wt. %, whereby maximum contents of 6 wt. % or 3 wt. % can still be fully appropriate. ZrO₂ is contained in an amount of 0-5 wt. %, in particular 0-3 wt. %. whereby a maximum content of 3 wt. % has been demonstrated to be sufficient in many cases. In addition, WO₃ and MoO₃, independently of one another, can each be contained in a quantity of 0-5 wt. % or 0-3 wt. %, but in particular from 0.1 to 3 wt. %.

It has been demonstrated as particularly preferred according to the invention if the sum of Al₂O₃+B₂O₃+Cs₂O+BaO+Bi₂O₃+PbO lies in the range of 15 to 80 wt. %, preferably 15 to 75 wt. %, in particular 20 to 70 wt. %. Since B₂O₃ is usually used with a maximum quantity of 35 wt. %, the remaining 45 wt. % is distributed among one or more of the polarizable oxides, BaO, Bi₂O₃, Cs₂O and PbO.

According to a preferred embodiment, the PbO content is advantageously adjusted to 0 to 70 wt. %, preferably 10-65 wt. %, more preferably 15-60 wt. %. Particularly preferred, 20 to 58 wt. %, 25 to 55 wt. %, in particular, 35 to 50 wt. % are contained.

According to a special embodiment, if the PbO content is more than 50 wt. %, in particular, if it is more than 60 wt. %, alkalis can be contained in the glass in a content of more than 3 wt. %, in particular, more than 4 wt. % or more than 5 wt. %, whereby no more than 10 wt. % should be contained, so that, nevertheless, the requirement for the quotient tan δ/ε′ of <5 will still be fulfilled. If the glasses according to the invention do not contain PbO, then they are preferably free of alkali according to the invention.

The glasses may also contain TiO₂ for adjusting the “UV edge” (absorption of UV radiation), although they may also in principle be free thereof. The highest content of TiO₂ preferably amounts to 10 wt. %, in particular, at most 8 wt. %, whereby at most 5 wt. % is preferred. A preferred minimum content of TiO₂ amounts to 1 wt. %. Preferably, at least 80% to 99%, in particular 99.9 or 99.99% of the TiO₂ contained is present as Ti⁴⁺. In several cases, Ti⁴⁺ contents of 99.999% have been demonstrated as important, whereby the melt is preferably produced under oxidative conditions. Oxidative conditions are thus particularly to be understood as those in which titanium is present as Ti⁴⁺ or is oxidized to this stage, in the above-indicated quantity. These oxidative conditions can easily be achieved in the melt, for example, by addition of nitrates, particularly alkali nitrates and/or alkaline-earth nitrates. An oxidative melt can also be obtained by blowing in oxygen and/or dry air. It is also possible to produce an oxidative melt by means of an oxidizing burner adjustment, e.g., when the batch is melted down.

If the TiO₂ contents of the glass composition are >2 wt. % and a batch with a total Fe₂O₃ content of >5 ppm is used, it is preferably refined with As₂O₃ and melted with nitrate. The nitrate is preferably added as an alkali nitrate with contents of >1 wt. % in order to suppress a coloring of the glass in the visible region (the formation of ilmenite (FeTiO₃) mixed oxide).

Although nitrate is added to the glass during the melting down, preferably in the form of alkali and/or alkaline-earth nitrates, the nitrate concentration in the finished glass after refining only amounts to a maximum of 0.01 wt. % and in many cases at most 0.001 wt. %.

The content of Fe₂O₃ preferably amounts to 0-5 wt. %, whereby quantities from 0-1 and, in particular, 0-0.5 wt. % are preferred. The content of MnO₂ amounts to 0-5 wt. %, whereby quantities from 0-2, in particular, 0-1 wt. % are preferred. The component MoO₃ is contained in an amount of 0-5 wt. %, preferably 0-4 wt. % and As₂O₃ and/or Sb₂O₃ are each contained in an amount of 0-1 wt. % in the glass according to the invention, whereby the minimum contents of the two together preferably amounts to 0.1, in particular 0.2 wt. %. The glass according to the invention, in a preferred embodiment, contains, if needed, small quantities of SO₄²⁻ of 0-2 wt. %, as well as Cl⁻ and/or F⁻ also in an amount of 0-2 wt. % for each.

Fe₂O₃ can be added to the glass in an amount of up to 1 wt. %. Preferably, however, the contents lie clearly below this amount.

If iron is contained, it is converted into its oxidation state of 3⁺ by the oxidizing conditions during the melt, for example, by use of nitrate-containing raw materials, whereupon discolorations in the visible wavelength region are minimized. Fe₂O₃ is preferably contained in the glass in contents of <500 ppm. Fe₂O₃ is generally present as an impurity.

In particular, a discoloration of the glasses, particularly upon addition of TiO₂ in contents of >1 wt. %, in the visible wavelength region can be at least partially avoided by keeping the glass melt essentially free of chloride and, in particular, no chloride and/or Sb₂O₃ is added for refining during the glass melting. It was found that a blue coloring of the glass, as occurs in particular with the use of TiO₂, can be avoided, if chloride is not employed as a refining agent. The maximum content of chloride as well as fluoride according to the invention amounts to 2, in particular 1 wt. %, whereby contents of a max. 0.1 wt. % are preferred.

In addition, it has been shown that sulfates such as, e.g., those that are utilized as refining agents, just like the above-named agents, also lead to a discoloration of the glass in the visible wavelength region. Therefore, sulfates are preferably also omitted. The maximum content of sulfates according to the invention amounts to 2 wt. %, in particular, 1 wt. %, whereby contents of a max. 0.1 wt. % are preferred. The wavelength region between 380 nm and 780 nm is understood as the visible wavelength region in the present [application for] patent protection.

In addition, it was found for the glasses that the previously described disadvantages can be avoided still further, if refining is conducted with As₂O₃, particularly under oxidizing conditions. Preferably, the glass contains 0.01-1 wt. % As₂O₃.

It has been shown that although the glasses are very stable relative to a solarization with UV irradiation, the solarization stability can be further increased by small contents of PdO, PtO₃, PtO₂, PtO, RhO₂, Rh₂O₃, IrO₂ and/or Ir₂O₃. The usual maximum quantity of such substances amounts to a maximum of 0.1 wt. %, preferably a maximum of 0.01 wt. %, whereby a maximum of 0.001 wt. % is particularly preferred. The minimum content for these purposes usually amounts to 0.01 ppm, whereby at least 0.05 ppm and, in particular, at least 0.1 ppm is preferred.

The above-named glass compositions are particularly designed for illuminating means with external electrodes, in which there is no sealing of the glass with electrode leads, i.e., EEFL lighting devices without electrode leads. Since the coupling is made by means of electric fields in the case of an electrode-less EEFL backlight, the glass compositions described below are also particularly suitable, which are characterized by an appropriate quotient of the loss factor and the dielectric constant in the range according to the invention:

| | | |
|---|---|---|
| SiO₂ | 35-65 | wt. % |
| B₂O₃ | 0-15 | wt. % |
| Al₂O₃ | 0-20 | wt. %, |
| preferably | 5-15 | wt. %, |
| Li₂O | 0-0.5 | wt. % |
| Na₂O | 0-0.5 | wt. % |
| K₂O | 0-0.5 | wt. %, whereby |
| the Σ Li₂O + Na₂O + K₂O amounts to | 0-1 | wt. %, and |
| MgO | 0-6 | wt. % |
| CaO | 0-15 | wt. % |
| SrO | 0-8 | wt. % |
| BaO | 1-20 | wt. %, |
| particularly BaO | 1-10 | wt. %, |
| TiO₂ | 0-10 | wt. %, |
| preferably amounts to | >0.5-10 | wt. %, |
| ZrO₂ | 0-1 | wt. % |
| CeO₂ | 0-0.5 | wt. % |
| Fe₂O₃ | 0-0.5 | wt. %, |
| WO₃ | 0-2 | wt. % |
| Bi₂O₃ | 0-20 | wt. % |
| MoO₃ | 0-5 | wt. %, |
| ZnO | 0-5 | wt. %, |
| preferably | 0-3 | wt. %, |
| PbO | 0-70 | wt. %, whereby |

the Σ Al₂O₃+B₂O₃+BaO+PbO+Bi₂O₃ amounts to 8-65 wt. %, wherein Hf, Ta, W, Re, Os, Ir, Pt, La, Pr, Nd, Sm, Eu, Gd, Tb, Dy, Ho, Er, Tm, Yb and/or Lu are present in oxide form in contents of 0-80 wt. %, as well as refining agents in the usual concentrations.

Further, the following glass compositions are preferred:

| | | |
|---|---|---|
| SiO₂ | 50-65 | wt. % |
| B₂O₃ | 0-15 | wt. % |
| Al₂O₃ | 1-17 | wt. %, |
| Li₂O | 0-0.5 | wt. % |
| Na₂O | 0-0.5 | wt. % |
| K₂O | 0-0.5 | wt. %, whereby |
| the Σ Li₂O + Na₂O + K₂O amounts to | 0-1 | wt. %, and |
| MgO | 0-5 | wt. % |
| CaO | 0-15 | wt. % |
| SrO | 0-5 | wt. % |
| BaO | 20-60 | wt. %, |
| particularly BaO | 20-40 | wt. %, |
| TiO₂ | 0-1 | wt. %, |
| ZrO₂ | 0-1 | wt. % |
| CeO₂ | 0-0.5 | wt. % |
| Fe₂O₃ | 0-1 | wt. %, |
| preferably | 0-0.5 | wt. %, |
| WO₃ | 0-2 | wt. % |
| Bi₂O₃ | 0-40 | wt. % |
| MoO₃ | 0-5 | wt. %, |
| ZnO | 0-3 | wt. %, |
| PbO | 0-30 | wt. %, |
| particularly PbO | 10-20 | wt. %, whereby |

the Σ Al₂O₃+B₂O₃+BaO+PbO+Bi₂O₃ amounts to 10-80 wt. %, wherein Hf, Ta, W, Re, Os, Ir, Pt, La, Pr, Nd, Sm, Eu, Gd, Th, Dy, Ho, Er, Tm, Yb and/or Lu are present in oxide form in contents of 0-80 wt. %, as well as refining agents in the usual concentrations.

All of the above-named glass compositions preferably contain the quantities of Fe₂O₃ indicated above and are most preferably essentially free of Fe₂O₃.

According to another preferred embodiment, the glass composition according to the invention is made of SiO₂ with and without dopings. Within the scope of the invention, dopings mean doping oxides, in particular, the oxides which were named individually with the respective quanites.

A preferred composition range of the glass compositions of this embodiment according to the invention is:

| | | |
|---|---|---|
| SiO₂ | 90-100 | wt. % |
| TiO₂ | 0-10 | wt. % |
| CeO₂ | 0-5 | wt. %. |

In this way, the upper limit of the SiO₂ content is reached by 100 wt. %—all the lower limits of the doping oxides present, i.e., the sum of all lower limits is subtracted; if, for example, the content of TiO₂ amounts to 5-10 wt. % and the content of CeO₂ amounts to 2-5 wt. %, the upper limit for SiO₂ is calculated by: 100−(5+2)=93 wt. %. Most particularly preferred, pure SiO₂ is present without doping.

The maximum content of TiO₂, in particular for UV blocking of the glass, amounts to 10 wt. %, whereby at most it amounts to 8 wt. %, in particular at most 5 wt. %, whereby contents between 1 and 4 wt. % are also possible. The CeO₂ content at most amounts to 5 wt. %, whereby quantities of 0 to 4 wt. %, in particular, 1 to 3 wt. %, and even more preferable, of less than 1 wt. % can also be adjusted. Additional oxides, which have already been described, may also be contained.

Methods for the production of SiO₂ glasses, in particular, of amorphous SiO₂ (silica glass, quartz glass) are, for example: gas-phase deposition, leaching of borosilicate glass and subsequent sintering, as well as production of a glass melt.

The glasses of the invention are particularly suitable for the production of flat glass, particularly according to the float method, wherein the production of tube glass is particularly preferred. Most particularly suitable are glasses for the production of tubes with a diameter of at least 0.5 mm, in particular at least 1 mm and an upper limit of at most 2 cm, in particular, at most 1 cm. Particularly preferred tube diameters amount to between 2 mm and 5 mm. It has been shown that such tubes have a wall thickness of at least 0.05 mm, in particular, at least 0.1 mm, whereby at least 0.2 mm is particularly preferred. Maximum wall thickness amounts to 1 mm at most, whereby wall thicknesses of <0.8 mm or <0.7 mm at most are preferred.

The glass of the illuminating means contains or consists of a glass composition, which additionally has a UV blocking action to the extent desired.

It has been shown that the glasses according to the invention, in particular, borosilicate glasses or pure or doped SiO₂ glasses, are particularly well suitable for the production of lamp glasses for illuminating means with external electrodes, in particular, gas-discharge tubes, as well as fluorescent lamps for EEFL fluorescent lamps (external electrode fluorescent lamps), in particular miniature fluorescent lamps, in particular, for the background illumination of electronic display devices, such as displays and LCD image screens, as well as back-lighting displays (passive displays, so-called displays with a backlight unit) as a light source, such as, for example, for computer monitors, in particular TFT devices, as well as in scanners, advertising signs, medical instruments and devices for air and space travel, as well as for navigation technology, in cell phones and in PDAs (personal digital assistants). Such fluorescent lamps for this application have very small dimensions and, correspondingly, the lamp glass has only an extremely small thickness. Preferred displays as well as image screens are so-called flat-screen displays, used in laptops, in particular flat-screen backlight arrangements.

The glasses according to the invention, which are indicated for illuminating means with external electrodes, are for example, for use in fluorescent lamps with external electrodes, whereby these external electrodes can be formed, for example, by an electrically conductive paste.

Additionally preferred is the use of the glasses described here in the form of flat glass for flat gas-discharge lamps.

In a special embodiment, the glass is used for the production of low-pressure discharge lamps, in particular of backlight arrangements.

According to a first variant according to the invention, at least two illuminating means are preferably disposed parallel to one another and are preferably found between the base or support plate and the cover or substrate plate or disk. Appropriately, one or more recesses is provided in the support plate, and the one or more illuminating means are accommodated in these recesses. Preferably, one recess receives one illuminating means each time. The emitted light of the one or more illuminating means is reflected onto the display or screen.

Advantageously, a reflection layer is introduced onto the reflecting support plate according to this variant, i.e., in particular, in the one or more recesses, and this layer uniformly scatters the light emitted from the illuminating means in the direction of the support plate as a type of reflector and thus provides for a homogeneous illumination of the display or image screen.

As a substrate or cover plate or disk, any usual plate or disk can be used for this purpose, which functions as the light diffusor unit or only as a cover, depending on the structure of the system and the purpose of application. The substrate or cover plate or disk accordingly can be, for example, an opaque diffusor disk or a clear transparent disk.

This arrangement according to the first variant of the invention is preferably used for larger displays, such as, for example, in television sets.

According to a second variant of the invention, the illuminating means corresponding to the system of the invention can also be arranged, for example, outside the light diffusor unit. Thus, the one or more illuminating means can be mounted externally, for example, onto a display or screen, whereby, by means of a light-transporting plate, a so-called LGP (light guide plate) serving as the light guide, the light is appropriately distributed uniformly over the display or the screen. Such light guide plates have a rough surface, for example, over which the light is distributed.

According to a third variant of the system according to the invention, an electrode-less lamp system, i.e., a so-called EEFL system (external electrode fluorescent lamp) can also be used.

In a preferred configuration of this third variant according to the invention, the light-generating unit, for example, has a surrounding space, which is bounded on top by a preferably structured disk, and on the bottom, by a support disk, as well as on the side by walls. For example, the illuminating means, such as fluorescent lamps, are found on the sides of the unit. This surrounding space, for example, can be divided further into individual radiation spaces, which can contain a discharge luminophore, which is applied, for example, in a predetermined thickness on a support disk. Again, depending on the system structure, an opaque diffusor disk or a clear transparent disk, or the like, can be used as a cover plate or disk.

A backlight arrangement of the invention according to this variant, for example, is an electrode-less gas-discharge lamp, i.e., there are no leads, but only outer or external electrodes.

Particularly suitable according to the invention is glass for fluorescent lamps, which contains Ar, Ne, and possibly Xe and Hg. In a particular embodiment, the fluorescent lamps, however, are free of Hg and contain Xe as the filling gas. This embodiment of an illuminating means, which is based on the discharge of xenon atoms (xenon lamps) has proven to be particularly environmentally friendly as an illuminating means that is free of halogen and mercury.

The invention will be described below in more detail on the basis of the drawings. Here:

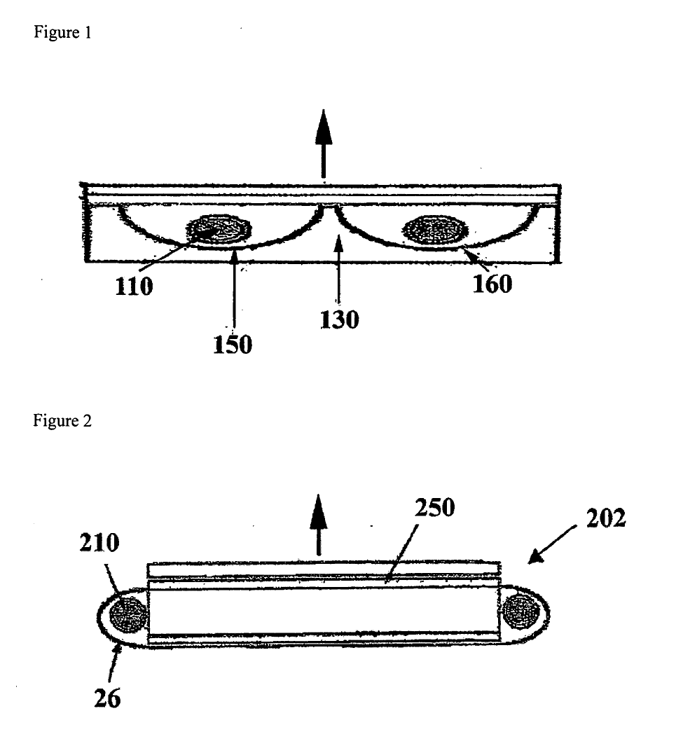

FIG. 1 shows a basic form of a reflecting base or support and substrate plate for a miniature backlight arrangement,

FIG. 2 shows a backlight arrangement with external electrodes and

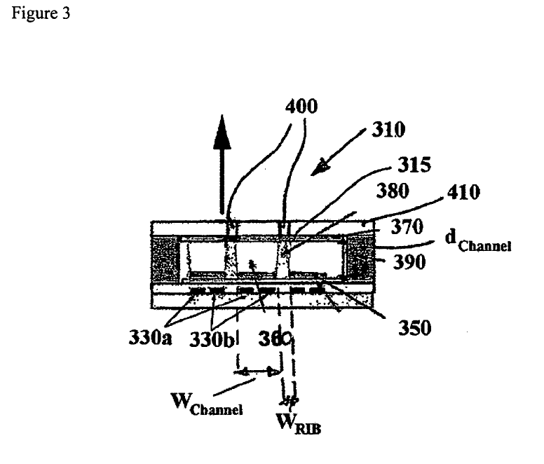

FIG. 3 shows a display arrangement with fluorescent lights mounted on the side.

The use of backlight lamps whose lamp body contains the glass composition according to the invention or consists of it is shown as an example in FIGS. 1 to 3.

FIG. 1 shows a special use for such arrangements, in which individual miniature fluorescent tubes 110, consisting of glasses according to the invention, are employed parallel to one another and are found in a plate 130 with recesses 150, which reflect the light emitted onto the display. A reflection layer 160 is introduced above the reflecting plate 130 and this layer uniformly scatters the light emitted from the fluorescent tubes 110 in the direction of plate 130, as a type of reflector, and thus provides for a homogeneous illumination of the display. This arrangement is preferred for use in larger displays, such as, e.g, in television sets.

According to the embodiment in FIG. 2, the fluorescent tubes 210 can also be introduced externally on display 202, whereby, by means of a light-transporting plate 250, a so-called LGP (light guide plate), serving as the light guide, the light is then distributed uniformly over the display.

In addition, it is also possibile to use it for backlight arrangements in which the light-generating unit 310 is found directly in a structured disk 315. This is shown in FIG. 3. Here, the structuring is such that channels with pregiven depth and pregiven width (d_{channel} or W_{channel}, respectively) are produced by means of parallel elevations, so-called barriers or ribs 380 with a pregiven width (W_{rib}) in the disk, and the discharge illuminating means 350 is found in these channels. Here, together with a disk, which is provided with a phosphor layer 370, the channels form several hollow radiation spaces 360. The backlight arrangement shown in FIG. 3 is an electrode-less gas discharge lamp, i.e., there are no leads, but rather only external electrodes 330a, 330b. The cover disk 410 shown in FIG. 3 can be an opaque diffusor disk or a clear transparent disk, depending on the system structure. In the electrode-less lamp system, which is shown in FIG. 3, one speaks of a so-called EEFL system (external electrode fluorescent lamp). The above-described arrangements form a large, flat backlight and are thus also denoted as a flat backlight.

The present invention will be explained below on the basis of examples, which illustrate the teaching according to the invention, but do not limit it.

### EXAMPLES

Glass compositions for glass bodies of illuminating means with external electrodes as well as the tan δ/DC quotient are indicated below. DC is the dielectric constant. The quotients of all the glass compositions according to the invention lie clearly below 5 and thus fulfill the established requirements.

TABLE 1

| Glass | Example | Example | Example | Example | Example | Example | Example |
|---|---|---|---|---|---|---|---|
| type | 1 | 2 | 3 | 4 | 5 | 6 | 7 |
| SiO₂ | 59.90 | 61.25 | 50.60 | 35.00 | 32.10 | 58.00 | 70.20 |
| B₂O₃ | 4.20 | 0.25 | 13.40 | | 2.40 | | 27.10 |
| Al₂O₃ | 14.30 | 16.50 | 11.80 | | | 1.50 | 0.70 |
| Li₂O | | | | | | | |
| Na₂O | | | | | | 4.30 | |
| K₂O | | | | 5.00 | 4.00 | 8.70 | 1.20 |
| MgO | 2.50 | | | | | | |
| CaO | 10.30 | 13.40 | | | | | |
| SrO | | | | | | | |
| BaO | 8.80 | 7.60 | 24.20 | | | | 0.80 |
| ZnO | | | | | | | |
| PbO | | | | 60.00 | 61.50 | 27.50 | |
| TiO₂ | | | | | | | |
| ZrO₂ | | 1.00 | | | | | |
| CeO₂ | | | | | | | |
| F | | | | | | | |
| Fe₂O₃ | | | | | | | |
| Sum | 100.00 | 100.00 | 100.00 | 100.00 | 100.00 | 100.00 | 100.00 |
| Quotient | 1.8 | 2.3 | 1.5 | 0.9 | 0.9 | 1.7 | 2.3 |
| tan δ/DC | | | | | | | |

TABLE 2

| Glass | Example | Example | Example | Example | Example | Example | Example |
|---|---|---|---|---|---|---|---|
| type | 8 | 9 | 10 | 11 | 12 | 13 | 14 |
| SiO₂ | 59.50 | 57.00 | 60.80 | 61.60 | 63.80 | 64.50 | 5.3 |
| B₂O₃ | 5.40 | 7.90 | 6.50 | 7.80 | 9.00 | 9.00 | 15 |
| Al₂O₃ | 15.50 | 16.80 | 16.00 | 16.20 | 16.50 | 15.50 | 5 |
| Li₂O | | | | | | | |
| Na₂O | | | | | | | |
| K₂O | | | | | | | |
| MgO | 5.00 | 5.10 | 5.30 | 2.70 | 4.50 | 2.80 | 3 |
| CaO | 7.20 | 2.10 | 7.40 | 8.20 | 3.00 | 5.00 | |
| SrO | | 6.60 | | | 3.20 | | |
| BaO | 1.00 | 3.30 | 1.00 | 3.50 | | 3.20 | 71.2 |
| ZnO | 5.40 | | 2.00 | | | | |
| PbO | | | | | | | |
| TiO₂ | | 0.50 | | | | | |
| ZrO₂ | 1.00 | 0.50 | 1.00 | | | | |
| CeO₂ | | 0.20 | | | | | |
| F | | | | | | | |
| Fe₂O₃ | | | | | | | 0.5 |
| Sum | 100.00 | 100.00 | 100.00 | 100.00 | 100.00 | 100.00 | 100.00 |
| Quotient | | 2.4 | | | | | |
| tan δ/DC | | | | | | | |

With the present invention, glass compositions are prepared, in which the glass properties can be influenced in a targeted manner by adjusting the quotient of the loss angle tan δ and the dielectric constant ε′. By taking care that the upper limit is 5 for this quotient according to the invention, it is possible, for the first time, with the teaching of the invention, to reduce to a minimum the total power loss of glass compositions and to thus obtain an optimal efficiency in illuminating means with external electrodes.

1. A glass composition for a glass body of an illuminating device with external electrodes, comprising:
a quotient of a loss angle and a dielectric constant that amounts to less than 5.

2. The glass composition according to claim 1, wherein the quotient amounts to less than 4.

3. The glass composition according to claim 1, wherein the quotient amounts to less than 3.

4. A high efficiency discharge lamp, comprising:
a glass body with external electrodes, the glass body having a quotient of a loss angle and a dielectric constant of less than 5; and
a power loss Pₗₒₛₛ given by:
$${P}_{loss} \approx 2 \cdot \frac{1}{ω} \cdot \frac{tan δ}{{ɛ}^{′}} \cdot \frac{d}{A} \cdot {I}^{2}$$
wherein ω is an angular frequency, tan δ is the loss angle, ε′ is the dielectric constant, d is a thickness of the glass body, A is a surface area of the external electrodes, and I is a current intensity.

5. The glass composition according to claim 1, comprising at least one highly polarizable element in oxide form.

6. The glass composition according to claim 5, wherein the at least one highly polarizable element in oxide form is selected from the group consisting of the oxides of Ba, Cs, Hf, Ta, W, Re, Os, Ir, Pt, Pb, Bi, La, Ce, Pr, Nd, Sm, Eu, Gd, Tb, Dy, Ho, Er, Tm, Yb, and Lu.

7. The glass composition according to claim 5, wherein the at least one highly polarizable element in oxide form is present in an amount of at least 8 wt. %.

8. The glass composition according to claim 5, wherein the at least one highly polarizable elements in oxide form is present in an amount of at least 20 wt. %.

9. The glass composition according to claim 1, further comprising:

| | | |
|---|---|---|
| SiO₂ | 55-85 | wt. % |
| B₂O₃ | >0-35 | wt. % |
| Al₂O₃ | 0-25 | wt. %, |
| Li₂O | <1.0 | wt. % |
| Na₂O | <3.0 | wt. % |
| K₂O | <5.0 | wt. %, wherein |
| the Σ Li₂O + Na₂O + K₂O amounts to | <5.0 | wt. %, and |
| MgO | 0-8 | wt. %, |
| CaO | 0-20 | wt. %, |
| SrO | 0-20 | wt. %, |
| BaO | 0-80 | wt. %, |
| TiO₂ | 0-10 | wt. %, |
| ZrO₂ | 0-3 | wt. %, |
| CeO₂ | 0-10 | wt. %, |
| Fe₂O₃ | 0-3 | wt. %, |
| WO₃ | 0-3 | wt. %, |
| Bi₂O₃ | 0-80 | wt. %, |
| MoO₃ | 0-3 | wt. %, |
| ZnO | 0-15 | wt. %, |
| PbO | 0-70 | wt. %, |

wherein the Σ Al₂O₃+B₂O₃+BaO+PbO+Bi₂O₃ amounts to 15-80 wt. %, wherein Hf, Ta, W, Re, Os, Ir, Pt, La, Pr, Nd, Sm, Eu, Gd, Tb, Dy, Ho, Er, Tm, Yb and/or Lu are present in oxide form in contents of 0-80 wt. %.

10. The glass composition according to claim 1, further comprising:

| | | |
|---|---|---|
| SiO₂ | 55-85 | wt. %, |
| B₂O₃ | >0-35 | wt. %, |
| Al₂O₃ | 0-20 | wt. %, |
| Li₂O | <0.5 | wt. %, |
| Na₂O | <0.5 | wt. %, |
| K₂O | <0.5 | wt. %, wherein |
| the Σ Li₂O + Na₂O + K₂O amounts to | <1.0 | wt. %, and |
| MgO | 0-8 | wt. %, |
| CaO | 0-20 | wt. %, |
| SrO | 0-20 | wt. %, |
| BaO | 15-60 | wt. %, |
| the Σ MgO + CaO + SrO + BaO amounts to | 15-70 | wt. %, |
| TiO₂ | 0-10 | wt. %, |
| ZrO₂ | 0-3 | wt. %, |
| CeO₂ | 0-10 | wt. %, |
| Fe₂O₃ | 0-1 | wt. %, |
| WO₃ | 0-3 | wt. %, |
| Bi₂O₃ | 0-80 | wt. %, |
| MoO₃ | 0-3 | wt. %, |
| ZnO | 0-10 | wt. %, |
| PbO | 0-70 | wt. %, wherein |

the Σ Al₂O₃+B₂O₃+Cs₂O+BaO+PbO+Bi₂O₃ amounts to 15-80 wt. %.

11. The glass composition according to claim 1, further comprising:

| | | |
|---|---|---|
| SiO₂ | 35-65 | wt. %, |
| B₂O₃ | 0-15 | wt. %, |
| Al₂O₃ | 0-20 | wt. %, |
| Li₂O | 0-0.5 | wt. %, |
| Na₂O | 0-0.5 | wt. %, |
| K₂O | 0-0.5 | wt. %, whereby |
| the Σ Li₂O + Na₂O + K₂O amounts to | 0-1 | wt. %, and |
| MgO | 0-6 | wt. %, |
| CaO | 0-15 | wt. %, |
| SrO | 0-8 | wt. %, |
| BaO | 1-20 | wt. %, |
| TiO₂ | 0-10 | wt. %, |
| ZrO₂ | 0-1 | wt. %, |
| CeO₂ | 0-0.5 | wt. %, |
| Fe₂O₃ | 0-0.5 | wt. %, |
| WO₃ | 0-2 | wt. %, |
| Bi₂O₃ | 0-20 | wt. %, |
| MoO₃ | 0-5 | wt. %, |
| ZnO | 0-5 | wt. %, |
| PbO | 0-70 | wt. %, whereby |

the Σ Al₂O₃+B₂O₃+BaO+PbO+Bi₂O₃ amounts to 8-65 wt. %, wherein Hf, Ta, W, Re, Os, Ir, Pt, La, Pr, Nd, Sm, Eu, Gd, Tb, Dy, Ho, Er, Tm, Yb and/or Lu are present in oxide form in contents of 0-80 wt. %.

12. The glass composition according to claim 1, further comprising:

| | | |
|---|---|---|
| SiO₂ | 50-65 | wt. %, |
| B₂O₃ | 0-15 | wt. %, |
| A1₂O₃ | 1-17 | wt. %, |
| Li₂O | 0-0.5 | wt. %, |
| Na₂O | 0-0.5 | wt. %, |
| K₂O | 0-0.5 | wt. %, whereby |
| the Σ Li₂O + Na₂O + K₂O amounts to | 0-1 | wt. %, and |
| MgO | 0-5 | wt. %, |
| CaO | 0-15 | wt. %, |
| SrO | 0-5 | wt. %, |
| BaO | 20-60 | wt. %, |
| TiO₂ | 0-1 | wt. %, |
| ZrO₂ | 0-1 | wt. %, |
| CeO₂ | 0-0.5 | wt. %, |
| Fe₂O₃ | 0-0.5 | wt. %, |
| WO₃ | 0-2 | wt. %, |
| Bi₂O₃ | 0-40 | wt. %, |
| MoO₃ | 0-5 | wt. %, |
| ZnO | 0-3 | wt. %, |
| PbO | 0-30 | wt. %, |

whereby the Σ Al₂O₃+B₂O₃+BaO+PbO+Bi₂O₃ amounts to 10-80 wt. %, wherein Hf, Ta, W, Re, Os, Ir, Pt, La, Pr, Nd, Sm, Eu, Gd, Tb, Dy, Ho, Er, Tm, Yb and/or Lu are present in oxide form in contents of 0-80 wt. %.

13. The glass composition according to claim 1, further comprising an alkali content of less than 1.0 wt. %.

14. The glass composition according to claim 13, wherein the alkali content is zero.

15. The glass composition according to claim 5, further comprising a content of BaO of greater than 15 wt. %.

16. The glass composition according to claim 5, further comprising a content of BaO of greater than 20 wt. %.

17. The glass composition according to claim 16, wherein the content of BaO lies between 20 wt. % and 80 wt. %.

18. The glass composition according to claim 1, further comprising a content of PbO of more than 50 wt. % and an alkali content of more than 3 wt. %.

19. The glass composition according to claim 1, further comprising a content of alkali of less than 1.0 wt. % when a PbO content is zero.

20. The glass composition according to claim 1, further comprising a content of BaO of less than 10 wt. % when a PbO content is greater than zero.

21. The glass composition according to claim 1, further comprising SiO₂ with or without doping oxides.

22. The glass composition according to claim 21, further comprising:

| | | |
|---|---|---|
| SiO₂ | 90-100 | wt. %, |
| TiO₂ | 0-10 | wt. %, and |
| CeO₂ | 0-5 | wt. %, |

wherein the upper limit of the SiO₂ content is given by: 100 wt. % less a sum of all of the lower limits of the oxides present, except for SiO₂.

23. The glass composition according to claim 1, consisting of SiO₂.

24. The glass composition according to claim 1, wherein the illuminating device is a discharge lamp.

25. The high efficiency discharge lamp according to claim 4, further comprising a discharge space filled with discharge substances selected from the group consisting of mercury, rare-earth ions, xenon, and any combinations thereof.

26. The glass composition according to claim 1, wherein the illuminating device is a fluorescent lamp.

27. The glass composition according to claim 1, wherein the illuminating device finds use in an electronic device selected from the group consisting of an image screen, an LCD display, a computer monitor, a TFT device, a telephone display, a cell phone display, a scanner, an advertising sign, a medical instrument, a navigation device, and a personal digital assistant.

28. A luminous device comprising a glass body having a glass composition with a quotient of a loss angle and a dielectric constant that amounts to less than 5.

29. The luminous device according to claim 28, wherein the luminous device finds use as an EEFL lamp, a gas-discharge lamp, an LCD display, a computer monitor, or a telephone display.
